(19) United States
(12) Patent Application Publication
(10) Pub. No.: US 2019/0109438 A1
(43) Pub. Date: Apr. 11, 2019

(54) HANDHELD NEGATIVE ION GENERATION APPARATUS AND METHOD OF USE

(71) Applicant: Kelley Eidem, Panama City, FL (US)

(72) Inventor: Kelley Eidem, Panama City, FL (US)

(21) Appl. No.: 15/729,734

(22) Filed: Oct. 11, 2017

(51) Int. Cl. H01T 23/00

(52) U.S. Cl. CPC H01T 23/00

(57) ABSTRACT

The embodiments disclosed provide an apparatus and method of use for a portable handheld negative ion and magnetic field generator wherein there is a housing from which a plurality wings protrude along a planar surface. The apparatus includes a plurality of magnets embedded in the wings and acrylic coated disks containing negative ion-producing minerals and/or compounds releasably attached to the wings. The apparatus is further configured to allow the user to spin the wings around the apparatus housing along their planar surface to generate a magnetic field and negative ions, and which causes the same to be in a constant state of flux.

### FIELD

The present embodiments relate to a portable handheld negative ion generator, and in particular, to a portable handheld negative ion generator apparatus comprised of a plurality of embedded acrylic coated disc releasably attached to the wings of the apparatus housing which electrically charge the surround air molecule when manually spun about its internal shaft.

### BACKGROUND

Several devices and toys of varying means and design have been created to permit a user to engage in a repetitive physical activity that does not require substantial movement or space. Spinning finger entertainment devices as toys, which are primarily comprised of a center unit that may be held between the user's fingers and a skirt that exists along a planar surface in the form of either an equally balanced disc or counterbalanced wings which protrude from the center unit, have existed in the art since at least 1997.

Spinning toys have been marketed in several shapes and sizes all following the above general composition. The single-handed and handheld nature of these devices makes them both portable and convenient for use in a variety of settings for most users. The joint between the center unit and the skirt of the spinning toy is typically comprised of a ball bearing or some other friction reducing joining device. Moreover, some iterations of these spinning toys incorporate additional weights in the skirt to increase the mass of the spinning portion and consequently its momentum to permit a faster and longer sustained spin. These spinning toys have traditionally been used and marketed for their entertainment value. Some art also references these toys for their therapeutic and stress-relieving effects incidental to the entertainment value derived from the physically repetitive and simple nature of the toy's use.

Currently there are several systems and methods which disclose aspects of toys and other devices that provide therapeutic benefits from magnetic fields and negative ion-generation such as U.S. Pat. App. No. 2012/0317843 to Bove; and Chinese Pat. App. No. 104841138 to Youxiang; However, these references do not disclose a portable handheld generator which fits within a user's pocket.

### SUMMARY OF THE INVENTION

The present embodiments provide an apparatus and method of use for a portable handheld negative ion and magnetic field generator which is configured to spin about its shaft to increase negative ion production. The apparatus includes a blow molded housing having a plurality of aerodynamic fins. The housing includes a hollow centerline aperture dimensioned to fit a shaft which extends past the top and bottom surfaces of the first and second sides of the housing. Further surround the shaft is a ball bearing configured to spin housing and aerodynamic wings which simultaneously gripping a shaft fitting located at the first and second end of the shaft. housing and the plurality of wings. The dimensioned fitting at the first and second end dimensioned allow the user to secure the shaft with a single hand while spinning the housing with the opposite hand. Further included within each of the aerodynamic fins is a cylindrically shaped aperture configured to allow an acrylic and/or magnetic disc to be releasably inserted. During use, the surrounding air molecules are infused with negative ion particles (i.e., anions).

The apparatus is configured to allow the user hold and use the apparatus with a single hand. The present embodiments provide a means of holding the apparatus housing at which the user may grip the apparatus housing by depressing the apparatus housing on both sides of the planar surface with fingers from the same hand. While grasped by the user, the apparatus is configured to allow the user to spin the plurality of wings by applying directional force along the planar housing and extended wings.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a handheld negative ion generation apparatus;

FIG. 2 is a detailed view of an acrylic insert;

FIG. 3 is an exploded view of the apparatus including the ball bearing and acrylic insert;

FIG. 4 is a view of the apparatus secured in a user's hand; and

FIG. is a view of the apparatus during operation.

### DETAILED DESCRIPTION

Before describing in detail exemplary embodiments, it is noted that the embodiments reside primarily in combinations of apparatus components related to a handheld negative ion generator apparatus. Accordingly, the apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Traditionally, negative ion generators have been mischaracterized as ionizing air filters or air purifiers which require the device to be plugged into an external power source and often produce only ozone. This ozone producing devices are beneficial in eliminating air particles and some airborne bacteria and viruses but have been found to be harmful to the user when exposed to large quantities. For example, it has been shown that when a person is exposed to ozone at a level greater than 50 parts per billion by volume they have developed lung irritation and chest pain.

The embodiments provided include a portable handheld negative ion generator which may be used in a variety of settings without the need for an external power source by simply spinning the housings around the shaft with a single hand to generate negative ions. The current apparatus incorporates the same principals of “corona discharge” commonly found in lightning or waterfall without requiring costly ionic light bulbs found in many commercial applications. Similar to waterfalls, mountains, and beaches which are natural generator of negative ions, the apparatus mechanically generates these odorless and invisible ions by simply causing the acrylic and magnetic insert to interact with the surrounding air molecules.

The embodiments produce negative ions that are orders of magnitude beyond what stationary negative ion disks generate without the need for an external power source other than the user's hand. The amounts of negative ions generated are similar to or possibly exceeding the number of ions produced per cubic centimeter, per second, by Niagara Falls. Niagara Falls typically produces negative ion readings of 100,000 cc/ps. The amount produced by the embodiment is based on the speed of the spinning action. The stationary readings of the disks are 7,000 cc/ps. When spinning, a three-winged embodiment of 21,000 cc/ps would create a wind speed many orders of magnitude beyond a normal indoor wind speed of nearly zero miles an hour, resulting in a negative ion release far exceeding the negative ion readings for Niagara Falls.

Vacationers pay large sums of money to experience in part the amazing feelings they get from visiting the ocean or a large waterfall due to the large amounts of negative ions generated by the crashing water. The embodiment is the first tool that lets them relive a little bit of that enjoyment and relaxation wherever they might be by accelerating the release of negative oxygen ions from the moisture/humidity in the air. The spaces between the wings of the embodiment produce air displacement and turbulence in the normal humidified air when the embodiment is spinning and that air comes in contact with the surface area of the disks that help to generate the ion production. Unlike other ion generating devices, this embodiment requires no batteries or other electric power source.

The typical response by users is a greater feeling of relaxation. They have the added benefit of not needing to wear a raincoat while using it or traveling thousands of miles to access them.

Furthermore, many electronic devices, including cell towers, microwave ovens, car consoles, wi-fi, cell phones, wireless phones, computers and computer screens, and smart meters are sources of added positive ions. These devices reduce the normal ration of negative to positive ions in the air. The embodiment helps to restore that imbalance of ions.

Rather than requiring expensive electric ion generators in each room of the users' homes, they can take the embodiment with them wherever they go.

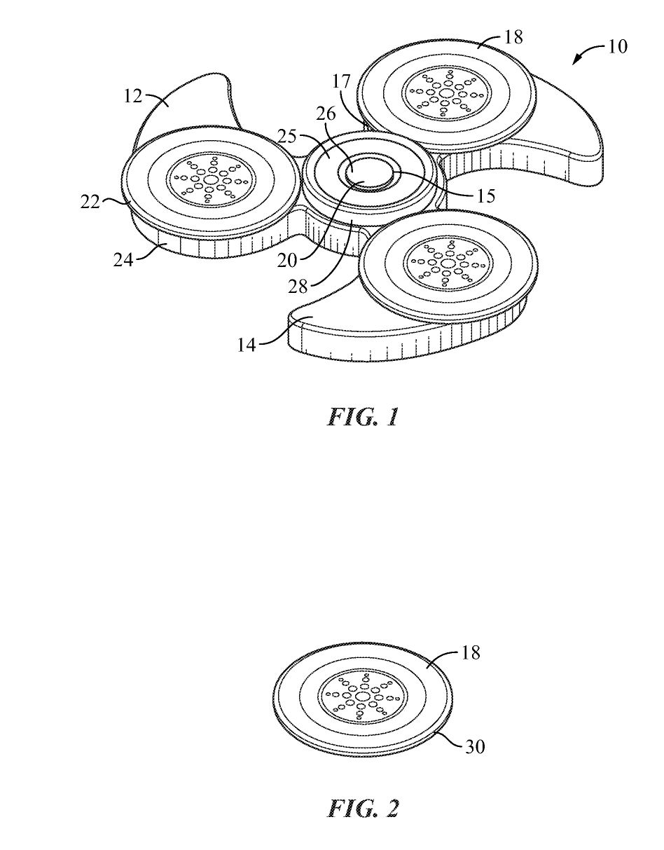

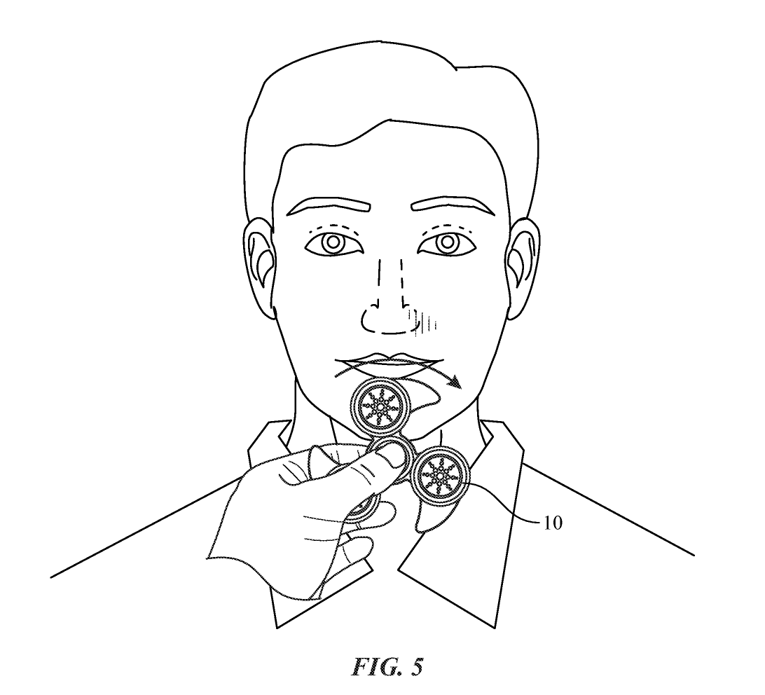

Referring now to the drawings where it is a shown in FIG. 1 a negative ion generation apparatus 10 which is configured to produce a plurality of negative charged ions in the surrounding air molecules. The handheld and portable apparatus 10 when grasped by a user and spin around its axis designed to produce thousands of negatively charged ions. The apparatus 10 is comprised of a planar housing 12 which includes a plurality of outwardly extending wings 14. Contained within the housing 12 of each aerodynamically shaped extending wings 14 is cylindrically shaped aperture 17 which is designed to releasably secure (i.e., attach) an acrylic disc attached to a magnetic insert 18. The apparatus 10 is designed to allow the user to grip a portion of the housing 12 or extending wing 14 with a finger and twirl the apparatus 10 about its centerline axis 15 having a linear shaft 20 which protrudes outward beyond both the top surface of the housing 22 and bottom surface of the housing 24. A fitting 25 is attached to the top side of the shaft 26 and bottom side of the shaft 28 when enable the user to secure grip the apparatus 10 with a thumb and finger further illustrated in FIG. 4. It is contemplated the housing 12 is comprised of a lightweight blow molded thermoplastic material. However, any suitable lightweight material such as a plastic or plastic substitute, wood, or metal may be used as long as it's aerodynamically shaped and allows the housing 12 to freely spin about the shaft 20. Surrounding the metallic shaft 20 is a ball bearing 28 which allows the user to grip the concave fitting 25 causing the shaft 20 to remain stationary while the housing 12 freely spins at the centerline axis 15. The apparatus 10 and discs 18 are uniformly aligned within their apertures 17 to enable rotation of a single plane during operation.

Negative ions are naturally produced from waterfalls, mountains, showers, or pounding surf and waves whereby these negative ions attach to positively charged particles causing germs, pollen, airborne bacteria and viruses to become too heavy to remain airborne. The apparatus may be used in both a commercial or residential setting and does not require routine maintenance.

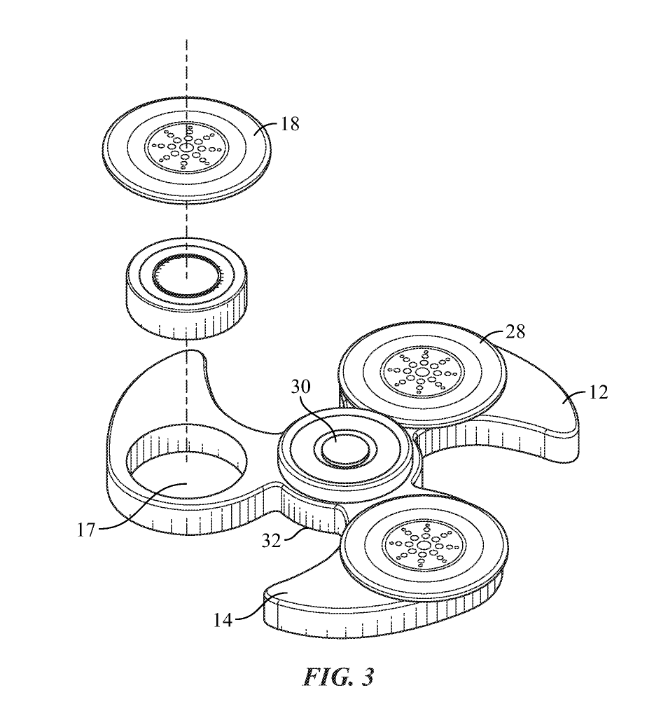

Now shown in FIG. 2 is an embodiment of the acrylic disc 18 which is comprised of plurality of minerals which produce negative ions. The acrylic disc is planar and when releasably attached to within the dimensioned aperture 17 is parallel to the top surface of the housing 22. Further the acrylic disc 18 is designed to be easily inserted and replaced by the user who may depress the bottom side of acrylic disc 30.

In the present embodiment, the disc 18 is comprised of acrylic produced from the methyl methacrylate monomer (MMA) and further infuses highly mineralized volcanic ash. Other embodiments may utilize different compositions for the disc 18 which likewise are capable of generating negative ion, such as titanium, tourmaline, germanium, zeolite, and monazite sand. When the acrylic disc 18 is caused to move, the disruption of the air molecules from the motion causes the disk to generate substantially greater quantities of negative ions directly proportional to the rotations per minute of the apparatus 10.

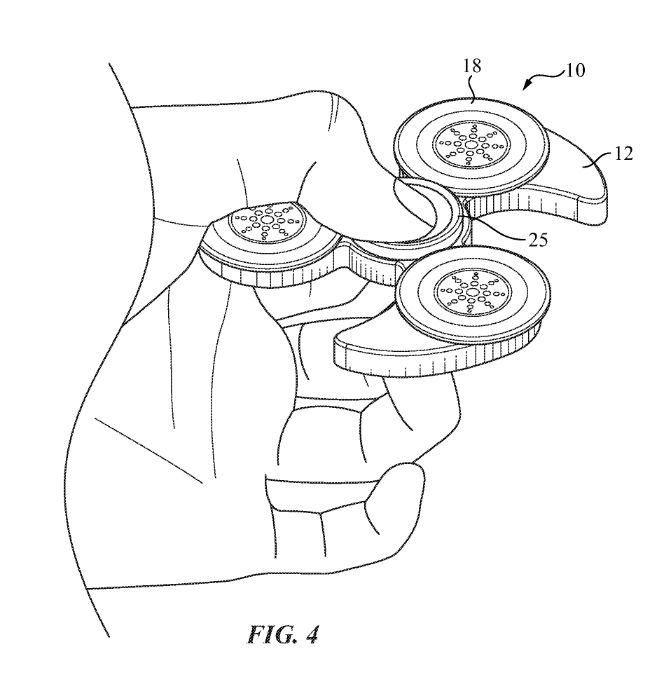

Shown in FIG. 3 is an exploded view of the apparatus 10 including the acrylic disc/magnetic 18 detached from the dimensioned aperture 17. The illustration further depicts a method in which the user may replace or exchange the acrylic disc 18 by pulling the acrylic disc 18 along the top edge of the acrylic disc 28 or turning the apparatus 10 over and pressing against the bottom of the acrylic disc 26 until dislodged from the dimensioned aperture 24. The user may then simply exchange inserts which are designed to be “popped” into the aperture 17, grip the shaft fitting 22 on the top side of the shaft 26 and bottom side of the shaft 28 using a thumb and finger and spin the apparatus 10.

Shown in FIG. 4 is a view of the apparatus 10 within a user hand with the user's thumb and forefinger securely placed on the concave fittings 25. In the present embodiment, a user would simply flick a portion of an extending wing 14 with their opposite hand to create rotation in a desired direction.

Shown in FIG. 5 is a view of the apparatus 10 during operation with the housing 12 and extending wings 14 rotating in clockwise direction around the shaft 20 and causing thousands of negative ions to create a barrier around the user. When the user has finished operating the apparatus 10, they may simply stop the housing 12 from rotating around the shaft 20 and store the apparatus 10 in their pocket.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A handheld negative ion generation apparatus, the apparatus comprising:
a substantially planar housing including a centerline shaft and having a plurality of aerodynamically shaped wings wherein a portion of each of the plurality of wings includes a cylindrically shaped aperture and at least one mineral infused acrylic insert configured to be releasably secured in the cylindrically shaped aperture and produce a plurality of negative ions when the apparatus is rotated.

2. The apparatus of claim 1, wherein the centerline shaft further includes a planar fitting configured to be releasably attached at a first end and a second end of the shaft to enable a user to secure the housing with a thumb and a forefinger.

3. The apparatus of claim 2, wherein the fitting is dimensioned to allow a user to grasp the apparatus with at least a thumb and one finger.

4. The apparatus of claim 1, wherein the housing further includes a ball bearing dimensioned to surround the centerline shaft and enable a user to rotate the planar housing about the shaft.

5. The apparatus of claim 4, wherein the planar housing is comprised of a high durometer blow molded polymer.

6. (canceled)

7. A rotatable air ionization apparatus configured to be fit within a user's hand, the apparatus including:
a substantially planar and blow molded housing including a centerline shaft having a fitting at first end of the shaft and a second end of the shaft, and plurality of aerodynamically shaped wings including a cylindrically shaped aperture and at least one mineral infused acrylic insert configured to be releasably secured in the cylindrically shaped aperture and produce a plurality of negative ions when the apparatus is rotated.

8. The apparatus of claim 7, wherein the first and the second end of the shaft are configured to protrude outward from a top surface and a bottom surface of the planar housing.

9. The apparatus of claim 7, wherein the fitting is concave.

10. The apparatus of claim 9, wherein the fitting is dimensioned to releasably secure a thumb and a finger of the user's hand.

11. The apparatus of claim 7, wherein the acrylic and magnetic insert is comprised of a plurality of minerals.

12. The apparatus of claim 7, further configured to be rotated and waved over a selected body part of user during use.

13. A rotatable and hand operated negative ion generation apparatus, the apparatus comprising:
a substantially planar housing including a first section adjacent to and affixed to a second section using a blow molded polymer and further including:
a centerline shaft including a concave shaft fitting at a first end of the shaft and a opposite second end of the shaft;
a ball bearing dimensioned to fit about the centerline shaft and configured to selectively rotate the planar housing;
a plurality of aerodynamically shaped wings extending outward from the planar housing further including a cylindrically shaped aperture; and
at least one mineral infused acrylic insert configured to be releasably secured in the cylindrically shaped aperture and produce a plurality of negative ions when the apparatus is rotated.

14. The apparatus of claim 13, wherein each of the plurality of wings further contains an equally weighted and counterbalanced magnetic metal weight to enable rotation of the housing along a single plane during operation.
